(19) United States
(12) Patent Application Publication
(10) Pub. No.: US 2002/0107302 A1
(43) Pub. Date: Aug. 8, 2002

(54) Monomeric dye inkjet printing ink formulations for invisible marking / identification

(76) Inventors: Nelson Zamora Escano, Kingsport, TN (US); George Gregory Benge, Fayetteville, NC (US); Randy Kyle Churchwell, Danville, IL (US); Linda Jane Adams, Kingsport, TN (US)

Correspondence Address: John R. Casperson, PO Box 2174, Friendswood, TX, 77549, US

(21) Appl. No.: 09/949,023

(22) Filed: Sep. 7, 2001

Related U.S. Application Data
(60) Provisional application No. 60/231,272, filed on Sep. 8, 2000.

(51) Int. Cl. C09D 5/00

(52) U.S. Cl. 523/160; 523/161

(57) ABSTRACT

This invention pertains to aqueous-based ink formulations for inkjet printing of invisible markings on the surface of articles for identification, authentication, sorting, etc. The ink formulations contain at least one near infrared monomeric (as opposed to copolymerized) dye which has been previously dispersed or dissolved in water, glycols, aliphatic alcohols, and are useful for printing by both Continuous inkjet (CIJ) and Drop-on-demand (DOD) methods. This invention also demonstrates the enhanced ability to formulate said inkjet ink formulations when a small amount of water-dissipatible sulfopolyester/amide is added. Also, melt extrusion blending is demonstrated to be an alternative manufacturing process for premixing current Eastman ClirCode™ copolymerizable dyes with the water-dissipatible sulfopolyesters without need for more expensive polymer process manufacturing steps.

### BACKGROUND OF THE INVETION

This invention pertains to aqueous-based ink formulations suitable for inkjet printing, both by continuous and drop-on-demand methods and which contain a near infrared monomeric dye dispersed or dissolved in aliphatic hydrocarbon solvents, glycols, water, polymer vehicles or in combination of each respective component.

It is desirable to provide intelligible markings on the surface of articles that are virtually invisible to the human eye for identification, authentication, sorting, etc., and to produce said markings via the use of both drop-on-demand and continuous inkjet printing applications.

It is known to use near infrared fluorescent compounds which have minimal light absorption of radiation in the visible range 400-700 nanometers (nm) and which have strong light absorption in the near infrared region about 700-900 nm with accompanying fluorescence to produce fluorescent radiation of wavelengths longer than the wavelength of excitation (U.S. Pat. Nos. 5,093,147; 5,336,714; 5,614,008).

Traditional methods for formulating aqueous inkjet inks typically comprise one or more dyes, a humectant, water, and various other additives (such as biocides, surfactants, etc.). However, near-infrared fluorescent dyes with appropriate properties for aqueous-based invisible markings are only negligibly soluble in water. When the dye is not properly solubilized or dispersed, the ink does not give the desired absorbance and fluorescence when printed. It is believed that this phenomenon is due to aggregation of the near-infrared fluorescent dye. When the dye molecules tend to aggregate, absorption occurs at low wavelengths, and very little, if any, fluorescence is observed.

Polymeric resins can be added to stabilize the dispersion of the dyes in inks, but the amount of resin in the ink needs to be minimized for inkjet inks to reduce inkjet printer problems due to clogging of the tiny orifices employed in such devices.

The prior art does not provide aqueous ink formulations derived from monomeric dye(s) dispersed or solubilized in a vehicle media such as aliphatic hydrocarbon solvents, glycols, water, and polymer vehicle systems (with minimal polymeric material) and/or combinations thereof so as to produce an ink suitable for inkjet printing devices.

Properly dispersed or solubilized monomeric dye in correct vehicle media could provide a wider range of inkjet application, formulation flexibility and improved ink/printer run-ability. The reduction and/or elimination of polymer content on the dispersion improves ink/printer run-ability due to avoidance of film formation that causes printhead orifice clogging and which adversely affects the printer start-up characteristics.

Another essential benefit of this disclosure is that the monomeric dye dispersion is much simpler and economical to prepare. The formulated inks are useful for printing markings such as barcodes on a variety of substrates, particularly paper or paper products, where detection or identification are required. The invisible markings could be on white or colored background.

### BACKGROUND ART

U.S. Pat. No. 4,540,595 (Acitelli, et al.) provides an ink which fluoresces in the near infrared and which is used to mark documents such as bank checks for automatic identification. The dyes used are phenoxazines, which impart blue color to the marked substrate and thus are not invisible. The preferred fluorescent material is 3,7-bis(diethylamino) phenoxazonium nitrate.

Certain inorganic rare earth compounds typified by neodymium (Nd), erbium (Er), and ytterbium (Yb) have been used to impart fluorescent markings that can be activated in the infrared to date cards (U.S. Pat. No. 4,202,491, Suzuki). Inks prepared from the insoluble rare earth metals are prone to clogging inkjet nozzles causing poor printer start-up and thus, in general, are not practical.

In U.S. Pat. No. 5,093,147 (Andrus, et. al.) inks are disclosed which are useful for printing infrared fluorescent invisible markings on the surface of an article using certain known polymethine (cyanine) laser dyes. The water based ink formulation disclosed contains a polyvinyl alcohol (PVA) resin to serve as a host for the dye. However, the excessive amounts of resin used could cause printer start-up problems due to clogging of the inkjet nozzles. In addition, the viscosity of the ink formulation disclosed is too high to be practical for both drop-on-demand (DOD) and continuous inkjet (CIJ) printing applications.

Certain 16,17-dialkoxyviolanthrones (also called dibenzanthrones) are known (U.S. Pat. No. 3,630,941) to be useful as infrared fluorescent markers when solubilized in various solvents, although they are not fluorescent in solid state. These high molecular weight compounds have essentially no water solubility and thus have no use for formulation of water based inks for inkjet printing.

Japanese Laid-Open Patent Application: Hei3-79683 (Hanada, et al.) discloses ink formulations containing infrared absorbing naphthalocyanine compounds useful for printing barcodes and for identifying documents to prevent falsification and forgery. Various melted waxes and thermoplastic resins are used as vehicles in combination with alcohol and aromatic hydrocarbons to produce non-aqueous inks. The high molecular weight naphthalocyanine compounds have essentially no water solubility and are not useful for formulating aqueous inks for inkjet printing. The marking method in this application does not utilize the fluorescence of naphthalocyanines when exposed to infrared radiation, but relies mainly on absorption of infrared radiation.

U.S. Pat. No. 5,336,714 discloses aqueous coating composition containing about 20 weight percent to about 35 weight percent of a water-dissipatable sulfopolyester having 0.10 ppm by weight to about 10 percent by weight of a thermally stable near infrared fluorophoric compound copolymerized therein and dispersed in water (65-80 weight percent). The ink formulation disclosed was not suitable for inkjet printing because of plugging or clogging of the jets.

U.S. Pat. No. 5,614,008 discloses ink formulation containing near infrared fluorophoric compound (U.S. Pat. No. 5,336,714) incorporated into a water-dissipatable polyester backbone. The cited ink formulation pertains to both continuous inkjet and drop-on-demand printing techniques. The sulfopolyester polymer backbone limits the use of the formulated ink to printers with single nozzle printheads such as the Domino, Videojet and Imaje line of printers. Using these inks on high-resolution multi-array inkjet printers such as Hewlett Packard (HP) personal printers and Scitex commercial printers could also create start-up problems due to clogging caused by film formation on the jet orifice.

Also, based on the prior art, it is surprising that monomeric dyes can be used to formulate suitable inks for inkjet printing which have good stability and which can be used for tagging various substrates for identification/authentication purposes. The print fluorescent stability has been achieved by the incorporation with small amounts of polymeric binder into the monomeric dye dispersion which eliminates desired wavelength of absorption loss.

### SUMMARY OF THE INVENTION

According to one embodiment of the invention, an aqueous ink composition suitable for use in inkjet printing comprises a water-based solution of a monomeric dye, a water dissipatable sulfopolyester/amide, an aliphatic polyol, and optional lower aliphatic alcohols, surface active agents, defoaming agents, corrosion inhibitors, and biocides.

The monomeric dye fluoresces at wavelengths longer than about 600 nm and is present in an amount of 0.001 to 1.0 weight percent.

The water dissipatable sulfopolyester/amide comprises monomer residues of at least one dicarboxylic acid; from about 4 to about 25 mole percent, based on the total of all acid, hydroxy and amino equivalents, of monomer residues of at least one difunctional sulfomonomer containing at least one sulfonate group bonded to an aromatic ring where the functional groups are hydroxy, carboxyl, carboxylate ester or amino, and monomer residues of at least one diol or a mixture of diol and a diamine, and is present in an amount of about 0.5 to about 10.0 weight percent.

The aliphatic polyol contains 2 or 3 carbon atoms and is present in an amount of about 5 to about 75 weight percent.

The lower aliphatic alcohol has no more than 3 carbon atoms, and may be present in an amount of up to about 15 weight percent.

The other additives are selected from the group consisting of a surface active agent, a defoaming agent, a corrosion inhibitor, and a biocide and may be present in an amount of up to about 2 weight percent.

The remainder of the ink composition consists essentially of water.

In another embodiment of the invention, from about 1 to about 1000 parts by weight of the monomeric dye are intimately combined with from about 500 to about 10,000 parts by weight of the least one water dissipatable sulfopolyester/amide, such as by melt blending and extrusion. The result composition can be employed to produce the above described inkjet ink formulation.

### DETAILED DESCRIPTION OF THE INVENTION

This invention relates to an aqueous ink composition suitable for use in inkjet printing. The composition is generally described as comprising between about 0.001 and 1.0 weight percent of at least one monomeric dye such as phthalocyanines, cyanines, naphthalocyanines and squaraines; between about 0.5 and 10.0 weight percent of at least one water dissipatable sulfopolyester/amide comprising monomer residues of at least one dicarboxylic acid, about 4 to 25 mole percent, based on the total of all acid, hydroxy and amino equivalents, of monomer residues of at least one difunctional sulfomonomer containing at least one sulfonate group bonded to an aromatic ring where the functional groups are hydroxy, carboxyl, carboxylate ester or amino, monomer residues of at least one diol or a mixture of diol and a diamine; and optionally, monomer residues of at least one difunctional monomer reactant selected from hydroxycarboxylic acids, amino carboxylic acids and amino alkanols; between about 2 and 75 weight percent of at least one aliphatic polyol containing 2 or 3 carbon atoms; and between about 0 and 15 weight percent of at least one lower aliphatic alcohol of no more than 3 carbon atoms; the remainder of the said ink consisting of water or optionally water plus up to about 2% weight percent, based on the total weight, of one or more additives selected from surface active agents, defoaming agents, corrosion inhibitors and biocides.

A first specifically described preferred ink composition is particularly useful for drop-on-demand (DOD) inkjet printing via the so-called “piezoelectric impulse” method. The composition is the forgoing generally described ink when comprised of between 45 and 75 weight percent of the at least one aliphatic polyol containing 2 or 3 carbon atoms; between about 2 and about 15 weight percent of the at least one lower aliphatic alcohol of no more than 3 carbon atoms; between about 0.01 and about 0.50 weight percent of the at least one corrosion inhibitor; and between about 0.01 and about 0.30 weight percent of the at least one biocide.

A second specifically described preferred ink composition is particularly useful for drop-on-demand (DOD) inkjet printing via the so-called “bubble jet” method. The composition is the forgoing generally described ink when comprised of between about 20 and about 60 weight percent of the at least one aliphatic polyol containing 2 or 3 carbon atoms; between about 0 and about 1.50 weight percent of at the least one surface active agent; between about 0.01 and about 0.50 weight percent of at the at least one corrosion inhibitor; and between about 0.01 and about 0.30 weight percent of the at least one biocide.

A third specifically described preferred ink composition is particularly useful for continuous inkjet (CIJ) printing using a multi-array inkjet imaging system from Scitex (Scitex Digital Printing, Inc., Dayton, Ohio 45420-4099). The composition is the forgoing generally described ink when comprised of between about 2 and about 8 weight percent of the at least one aliphatic polyol containing 2 or 3 carbon atoms; between about 0.35 and about 0.65 weight percent of the at least one surface active agent; between about 0.75 and about 1.25 weight percent of the at least one defoaming agent; between about 0.01 and about 0.50 weight percent of the at least one corrosion inhibitor; and between about 0.01 and about 0.30 weight percent of the at least one biocide.

A fourth specifically described preferred ink composition is particularly useful for single nozzle continuous inkjet (CIJ) printers Such as Domino Codebox2, supplied by Domino Amjet, Inc., Gurnee, Ill. 60031. The composition is the forgoing generally described ink when comprised of between about 20 and about 40 weight percent of the at least one aliphatic polyol containing 2 or 3 carbon atoms; between about 5 and about 15 weight percent of the at least one aliphatic alcohol containing no more than 3 carbon atoms; between about 0.01 and about 0.50 weight percent of the at least one corrosion inhibitor; and between about 0.01 and about 0.30 weight percent of the at least one biocide.

The term “aliphatic polyol” is used to include ethylene glycol, propylene glycol, diethylene glycol, triethylene glycol, glycerol and mixtures of these.

The term lower “aliphatic alcohol” is used to include methanol, ethanol, n-propanol, isopropanol, ethylene glycol mono C1-C2 alkyl ethers and mixtures of these.

The term “monomeric dye” refers to near infrared fluorescent compounds which have minimal light absorption of radiation in the visible range 400-700 nanometers (nm) and which have strong light absorption in the near infrared region about 700-900 nm with accompanying fluorescence to produce fluorescent radiation of wavelengths longer than the wavelength of excitation (U.S. Pat. Nos. 5,093,147; 5,336,714; 5,614,008, 5,525,516). The monomeric dyes used include IR absorbing dyes selected from the classes of phthalocyanines, cyanines, naphthalocyanines, squaraines, and mixtures of these. The preferred dyes are selected from the classes of cyanine, squaraines, and phthalocyanines.

The term “biocide” is used to describe various anti-fungal compounds used to prevent or control the growth of various fungi upon prolonged standing of the ink compositions. A preferred biocide is 1,2-benzisothiazolin-3-one (Proxel® GXL, provided by Americas Inc., Wilmington, Del. 19897).

Preferred surface active agents or surfactants are the nonionic types containing Polyalkylene oxide moieties. A particularly preferred type of nonionic surfactant is obtained by ethoxylating acetylenic diols, such as ethoxylated tetramethyl decynediol (Surfynol 465, provided by Air Products and Chemicals, Inc., Allentown, Pa. 18195).

The activity of the surfactant may be controlled by the addition of a defoaming agent or defoamer. A preferred defoamer comprises a mixture of tetramethyldecynediol and propylene glycol (Surfynol 104PG, provided by Air Products and Chemicals, Inc., Allentown, Pa. 18195).

Corrosion inhibitors are added to the ink formulations to inhibit or reduce corrosion of the metal parts, particularly the nozzle/orifice of the inkjet printers. A preferred class of corrosion inhibitors is the 1H-benzotriazoles and 1H-benzotriazole itself is the preferred corrosion inhibitor (Cobratec 99, provided by PMC Specialties Inc., Cincinnati, Ohio).

In another embodiment of this invention the water-dissipatible sulfopolyester/amide may be mixed with the monomeric fluorescent dyes which are thermally stable by melt blending and extruding with a single or twin-screw extruder at temperatures of about 250-300° C. This “premix” of sulfopolyester/amide plus fluorescent dye may be used to replace the sulfopolyester/amides in the composition described above and in the examples below.

The following examples further illustrate the practice of the invention. It is essential to pre-disperse the monomeric dye in a suitable vehicle system to achieve homogeneity of the solution/dispersion. A number of various near-infrared fluorescent dyes have been examined; they are given in Table 1 along with pertinent info such as chemical name, CAS registry number, chemical structure, and supplier. The dispersion vehicle systems used for this invention are selected from propylene glycol, water, ethanol, water-dissipatable sulfopolyester polymer, methyl ethyl ketone and an equal combination mixture of acetone and water. The preferred dispersion vehicle being propylene glycol Small amounts of surfactants could also be added in the preparation to improve dye solubility and avoid foaming. Preferably, surfactants are added only as needed.

### EXAMPLE

Water-Dissipatable Sulfopolyester Vehicle:

| Component | Parts | |
|---|---|---|
| I | 12.67 parts | water-dissipatable sulfopolyester polymer |
| | | pellets (Eastman AQ48 polymer, Eastman |
| | | Chemical Company, Kingsport, TN) |
| II | 14.07 parts | deionized water |
| III | 73.26 parts | propylene glycol |
| | 100.00 parts | |

Components I-III were weighed into a vessel and mixed to create a sufficient shear using a propeller mixer. Temperature was raised to 90° C. and held until the polymer pellets were fully dispersed. The vehicle was then allowed to cool to room temperature.

### EXAMPLE 2

Preparation of Dispersion From Dye I (Table 1) at 1200 ppm:

| Component | Parts | |
|---|---|---|
| I | 0.12 parts | Dye I in Table 1 |
| II | 99.88 parts | propylene glycol |
| | 100.00 parts | |

Components I-II were weighed into a vessel and mixed to create a sufficient shear using a propeller mixer until Component I has completely solubilized in Component II.

### EXAMPLE 3

Preparation of Dispersion From Dye I (Table 1) at 600 ppm:

Equal parts (weight percent) of Example 1 and Example 2 were combined and mixed at moderate shear using a propeller mixer until a complete homogeneous mixture was obtained. The resulting composition at 600 ppm aluminum phthalocyanine chloride dispersion is as follows:

| Component | Parts | |
|---|---|---|
| I | 0.06 parts | Dye I in Table 1 |
| II | 6.34 parts | water-dissipatable sulfopolyester polymer |
| | | pellets (Eastman AQ 48 polymer, Eastman |
| | | Chemical Company, Kingsport, TN) |
| III | 7.04 parts | deionized water |
| IV | 86.56 parts | propylene glycol |
| | 100.00 parts | |

### EXAMPLE 4

Preparation of Inkjet Ink From Dye I (Table 1) for Continuous Inkjet Printing with 3.0% (Dry Weight) Water-Dissipatable Sulfopolyester Polymer.

| Component | Parts | |
|---|---|---|
| I | 10.00 parts | Example 3 |
| II | 25.10 parts | propylene glycol |
| III | 47.80 parts | deionized water |
| IV | 8.00 parts | water-dissipatable sulfopolyester polymer |
| | | (Eastman AQ48 polymer, Eastman Chemical |
| | | Company) at 30% (weight) in deionized |
| | | water |
| V | 0.05 parts | corrosion inhibitor (50% by weight solution |
| | | of 1H-benzotriazole (PMC Specialties) in |
| | | propylene glycol |
| VI | 0.05 parts | Proxel ® GXL (30% by weight in water) |
| VII | 9.00 parts | n-propyl alcohol |
| | 100.00 parts | |

Components I-VII were combined to produce an inkjet ink containing about 60 ppm of the monomeric dye and mixed at moderate shear using a propeller mixer until a homogeneous mixture was obtained. The ink produced was vacuum filtered in series through a depth filter (extra thick glass fiber filter), Versapore 3000 (3 μ), Versapore 1200 (1.2 μ) and Versapore 800 (0.8 μ) filters from Gelman Sciences.

When an ink drawdown was made on Springhill 20 lb. Paper using a RK#1 rod and RK Coater with speed setting of 3.5 and dried at 100° C. for 10 seconds using VWR air flow Oven, the ink produced was found to have a measured fluorescent voltage signal of 6.10 volts using an AccuSort L1.0 Scanner from AccuSort Systems Inc., Telford, Pa. 18969 at 670 nm using an ACS Spectro Sensor II from Applied Color System Inc., 5 Princess Rd., Lawrenceville, N.J. 08648 and high fluorescence visibility under handheld CCD (Charge Coupled Device) camera (Wizard V6) from V.L. Engineering Inc., Cincinnati, Ohio.

### EXAMPLE 5

Preparation of Inkjet Ink From Dye I (Table 1) for Continuous Inkjet Printing with 0.60% (Dry Weight) Water-Dissipatable Sulfopolyester Polymer.

| Component | Parts | |
|---|---|---|
| I | 10.00 parts | Example 3 |
| II | 33.80 parts | propylene glycol |
| III | 47.10 parts | deionized water |
| IV | 0.05 parts | corrosion inhibitor (50% by weight solution |
| | | of 1H-benzotriazole (PMC Specialties) in |
| | | propylene glycol |
| V | 0.05 parts | Proxel ® GXL (30% by weight in water) |
| VI | 9.00 parts | n-propyl alcohol |
| | 100.00 parts | |

Components I-VI were combined to produce an inkjet ink containing about 60 ppm of the monomeric dye. The ink drawdown made on Springhill 20 lb. paper using RK#1 rod and RK Coater with speed setting at 3.5 produced a measured fluorescent voltage of 4.40 volts using AccuSort L1.0 Scanner and spectral absorbance peak at 670 nm fluorescence visibility through a CCD camera.

Other monomeric dye dispersions that could be used to produce invisible marking inkjet inks include:

### EXAMPLE 6

A solution/dispersion of Dye II (Table 1) at about 0.06% (weight percent) or equivalent to 600 ppm concentration in about 99.94% (by weight) propylene glycol.

### EXAMPLE 7

A solution/dispersion of Dye II (Table 1) at about 0.12% (weight percent) or equivalent to 1200 ppm concentration in about 99.88% (by weight) propylene glycol.

### EXAMPLE 8

A solution/dispersion of Dye I (Table 1) at about 0.06% (weight percent) or equivalent to 600 ppm concentration in about 24.99% (weight percent) propylene glycol and 74.95% (weight percent) Example 1.

### EXAMPLE 9

A solution/dispersion of Dye I (Table 1) at about 0.06% (weight percent) or equivalent to 600 ppm concentration in about 49.97% (weight percent) propylene glycol and 49.97% (weight percent) Example 1.

### EXAMPLE 10

A solution/dispersion of Dye I (Table 1) at about 0.06% (weight percent) or equivalent to 600 ppm concentration in about 74.95% (weight percent) propylene glycol and about 24.99% (weight percent) Example 1.

### EXAMPLE 11

A solution/dispersion of Dye I (Table 1) at about 0.06% (weight percent) or equivalent to 600 ppm concentration in about 99.94% (weight percent) propylene glycol.

### EXAMPLE 12

A solution/dispersion of Dye I (Table 1) at about 0.06% (weight percent) or equivalent to 600 ppm concentration in about 98.44% (weight percent) Example 1, and about 1.5% (weight percent) Surfynol 465 (ethoxylated tetramethyl decynediol from Air Products and Chemicals Inc.).

### EXAMPLE 13

A solution/dispersion of Dye II (Table 1) at about 0.06% (weight percent) or equivalent to 600 ppm concentration in about 49.94% (weight percent) propylene glycol and 50.0% (weight percent) Example 1.

### EXAMPLE 14

Preparation of inkjet ink for continuous inkjet printing from Dye II (Table 1) with 3.0% (dry weight) water-dissipatable sulfopolyester polymer.

| Components | Parts | |
|---|---|---|
| I | 10.00 parts | Example 13 |
| II | 25.10 parts | propylene glycol |
| III | 47.80 parts | deionized water |
| IV | 8.00 parts | water-dissipatable sulfopolyester polymer |
| | | (Eastman AQ 48 pellets) at 30 % (weight |
| | | percent) in deionized water. |
| V | 0.05 parts | corrosion inhibitor (50% by weight solution |
| | | of 1H-benzotriazole in propylene glycol |
| VI | 0.05 parts | Proxel ® GXL (30% by weight in water) |
| VII | 9.00 parts | n-propyl alcohol |
| | 100.00 parts | |

Components I-VII were combined to produce an inkjet ink containing about 60 ppm of the Dye II (Table 1). The ink drawdown made on Springhill 20 lb. paper using RK#1 rod and RK Coater with speed setting at 3.5 produced a measured fluorescent voltage signal of 2.70 volts using an AccuSort L1.0 Scanner at 670 nm (nanometer) wavelength. The fluorescence of the ink is visible through a handheld CCD (Charge Coupled Device) camera from V.L. Engineering.

### EXAMPLE 15

Preparation of Inkjet Ink for Continuous Inkjet Printing From Dye II (Table 1) with 0.60% (Dry Weight) Water-Dissipatable Sulfopolyester Polymer.

| Components | Parts | |
|---|---|---|
| I | 10.00 parts | Example 13 |
| II | 33.80 parts | propylene glycol |
| III | 47.10 parts | deionized water |
| IV | 0.05 parts | corrosion inhibitor (50% by weight solution |
| | | of 1H-benzotriazole in propylene glycol) |
| V | 0.05 parts | Proxel ® GXL (30% by weight in water) |
| VI | 9.00 parts | n-propyl alcohol |
| | 100.00 parts | |

Components I-VI were combined to produce an inkjet ink containing about 60 ppm. Dye II (Table 1) and about 0.60% (dry weight) water-dissipatable sulfopolyester polymer. When an ink drawdown was made on Springhill 20 lb. paper using RK#1 rod and RK Coater at 3.5 speed setting, a fluorescent voltage signal of 2.35 volts was measured using an AccuSort L 1.0 Scanner and spectral absorbance at 670 nm (nanometers) wavelength. The fluorescence of the ink is visible through a handheld CCD (Charge Coupled Device) camera from V. L. Engineering.

Several sets of monomeric dyes which fluoresce or have spectral absorbance peaks between 650 nm-900 nm wavelengths were solubilized or dispersed in different vehicle systems such as glycols, water, surfactants, polymers, aliphatic alcohols, ketones or mixtures of these in order to further illustrate the practice of this invention.

### EXAMPLE 16

Dye I (Table 1) Was Dispersed at 0.06% (By Weight) Dye or 600 ppm Dye Concentration In Each of the Following Vehicle Systems with the Following Results:

| | | Solubility or | Fluorescence |
|---|---|---|---|
| ID | Vehicle System | Dispersibility | in near-IR |
| A | Water | Insoluble | No |
| B | Water with 1% ammonium | Insoluble | No |
| | hydroxide | | |
| C | Acetone | Insoluble | No |
| D | 50/50 acetone/water | Soluble | Yes |
| E | Methyl ethyl ketone | Insoluble | No |
| F | Ethyl acetate | Insoluble | No |
| G | Ethanol | Partially Soluble | Yes |
| H | Methyl acetate | Insoluble | No |
| I | Propylene glycol with 1% | Soluble | Yes |
| | (by weight) Surfynol 465 | | |
| | surfactant | | |

### EXAMPLE 17

Repeated Example 16 Dispersion using Dye II (Table 1) at About 0.06% (By Weight) Dye or Equivalent to 600 ppm Dye Concentration. The Results are as Follows:

| | | Solubility or | Fluorescence |
|---|---|---|---|
| ID | Vehicle System | Dispersibility | in near-IR |
| A | Water | Insoluble | No |
| B | Water with 1% ammonium | Insoluble | No |
| | hydroxide | | |
| C | Acetone | Partially Soluble | Yes |
| D | 50/50 acetone/water | Partially Soluble | Yes |
| E | Methyl ethyl ketone | Partially Soluble | Yes |
| F | Ethyl acetate | Partially Soluble | Yes |
| G | Ethanol | Soluble | Yes |
| H | Methyl acetate | Insoluble | No |
| I | Propylene glycol | Soluble | Yes |

### EXAMPLE 18

Repeated Example 16 Dispersions Using Dye III (Table 1) at 0.06% (by weight) dye or Equivalent to 600 ppm Dye Concentration. The Results are as Follows:

| | | Solubility or | Fluorescence |
|---|---|---|---|
| ID | Vehicle System | Dispersibility | in near-IR |
| A | Water | Insoluble | No |
| B | Water with 1% ammonium | Insoluble | No |
| | hydroxide | | |
| C | Acetone | Partially Soluble | Yes |
| D | 50/50 acetone/water | Insoluble | No |
| E | Methyl ethyl ketone | Partially Soluble | Yes |
| F | Ethyl acetate | Soluble | Yes |
| G | Ethanol | Insoluble | No |
| H | Methyl acetate | Soluble | Yes |
| I | Propylene glycol | Insoluble | No |

### EXAMPLE 19

Dye IV (Table 1) Was Dispersed at 0.06% (By Weight) Dye or 600 ppm Dye Concentration in each of the Following Vehicle Systems With the Following Results:

| | | Solubility or | Fluorescence |
|---|---|---|---|
| ID | Vehicle System | Dispersibility | in near-IR |
| A | Water | Insoluble | No |
| B | Water with 1% ammonium | Insoluble | No |
| | hydroxide | | |
| C | Acetone | Soluble | Yes |
| D | 50/50 acetone/water | Soluble | Yes |
| E | Methyl ethyl ketone | Soluble | Yes |
| F | Ethyl acetate | Soluble | Yes |
| G | Ethanol | Soluble | Yes |
| H | Methyl acetate | Soluble | Yes |
| I | Propylene glycol | Soluble | Yes |

### EXAMPLE 20

Repeated Example 19 Using Dye V (Table 1) at 0.06% (by Weight) Dye or Equivalent to 600 ppm Dye Concentration. The Results are as Follows:

| | | Solubility or | Fluorescence |
|---|---|---|---|
| ID | Vehicle System | Dispersibility | in near-IR |
| A | Water | Insoluble | No |
| B | Water with 1% ammonium | Insoluble | No |
| | hydroxide | | |
| C | Acetone | Soluble | Yes |
| D | 50/50 acetone/water | Soluble | Yes |
| E | Methyl ethyl ketone | Soluble | Yes |
| F | Ethyl acetate | Insoluble | No |
| G | Ethanol | Soluble | Yes |
| H | Methyl acetate | Partially Soluble | Yes |

### EXAMPLE 21

Repeated Example 19 Using Dye VI (Table 1) at 0.06% (Weight) Dye or 600 ppm Dye Concentration. The Results are as Follows:

| | | Solubility or | Fluorescence |
|---|---|---|---|
| ID | Vehicle System | Dispersibility | in near-IR |
| A | Water | Insoluble | No |
| B | Water with 1% ammonium | Insoluble | No |
| | hydroxide | | |
| C | Acetone | Insoluble | No |
| D | 50/50 acetone/water | Partially Soluble | Yes |
| E | Methyl ethyl ketone | Insoluble | No |
| F | Ethyl acetate | Insoluble | No |
| G | Ethanol | Partially Soluble | Yes |
| H | Methyl acetate | Insoluble | No |

### EXAMPLE 22

Repeated Example 19 Using Dye VII (Table 1) at 0.06% (by Weight) Dye or 600 ppm Dye Concentration. The Results as Follows:

| | | Solubility or | Fluorescence |
|---|---|---|---|
| ID | Vehicle System | Dispersibility | in near-IR |
| A | Water | Soluble | Yes |
| B | Water with 1% ammonium | Soluble | Yes |
| | hydroxide | | |
| C | Acetone | Insoluble | No |
| D | 50/50 acetone/water | Soluble | Yes |
| E | Methyl ethyl ketone | Insoluble | No |
| F | Ethyl acetate | Insoluble | No |
| G | Ethanol | Soluble | Yes |
| H | Methyl acetate | Insoluble | No |
| I | Propylene glycol | Soluble | Yes |

### EXAMPLE 23

Repeated Example 19 Using Dye VIII at 0.06% (by Weight) Dye or Equivalent to 600 ppm Dye Concentration. The Results are as Follows:

| | | Solubility or | Fluorescence |
|---|---|---|---|
| ID | Vehicle System | Dispersibility | in near-IR |
| A | Water | Soluble | Yes |
| B | Water with 1% ammonium | Partially Soluble | Yes |
| | hydroxide | | |
| C | Acetone | Soluble | Yes |
| D | 50/50 acetone/water | Soluble | Yes |
| E | Methyl ethyl ketone | Soluble | Yes |
| F | Ethyl acetate | Insoluble | No |
| G | Propylene Glycol | Soluble | Yes |

### EXAMPLE 24

Repeated Example 19 Using Dye IX at 0.06% (by Weight) Dye or 600 ppm Dye Concentration. The Results are as Follows:

| | | Solubility or | Fluorescence |
|---|---|---|---|
| ID | Vehicle System | Dispersibility | in near-IR |
| A | Water | Insoluble | No |
| B | Water with 1% ammonium | Insoluble | No |
| | hydroxide | | |
| C | Acetone | Soluble | Yes |
| D | 50/50 acetone/water | Soluble | Yes |
| E | Methyl ethyl ketone | Partially Soluble | Yes |
| F | Ethyl acetate | Partially Soluble | Yes |
| G | Ethanol | Partially Soluble | Yes |
| H | Methyl acetate | Insoluble | No |

### EXAMPLE 25

Repeated Example 19 Using Dye X at 0.06% (by Weight) Dye or 600 ppm Dye Concentration. The Results are as Follows:

| | | Solubility or | Fluorescence |
|---|---|---|---|
| ID | Vehicle System | Dispersibility | in near-IR |
| A | Water | Insoluble | No |
| B | Water with 1% ammonium | Insoluble | No |
| | hydroxide | | |
| C | Acetone | Soluble | Yes |
| D | 50/50 acetone/water | Soluble | Yes |
| E | Methyl ethyl ketone | Soluble | Yes |
| F | Ethyl acetate | Insoluble | No |
| G | Ethanol | Soluble | Yes |
| H | Methyl acetate | Partially Soluble | Yes |
| I | Propylene glycol | Soluble | Yes |

Based on the above dispersions, aqueous based inkjet inks could be formulated for drop-on-demand application such as piezo electric, bubble jet and thermal DOD and for both single nozzle and multi-array continuous inkjet printing. Following are examples of inks based on the dispersions prepared in the previous Examples.

### EXAMPLE 26

Preparation of Inkjet Ink From Dye IV (Table 1) at About 0.06% (by Weight) Dye or 600 ppm Dye Concentration for Continuous Inkjet Printing and with 3.0% (Dry Weight) Water-Dissipatable Sulfopolyester Polymer.

| Components | Parts | |
|---|---|---|
| I | 10.00 parts | Example 19(D) |
| II | 80.00 parts | inkjet vehicle containing 37.70% (by weight) |
| | | propylene glycol, 53.20% (by weight) |
| | | deionized water, 0.05% (by weight) |
| | | corrosion inhibitor, 0.05% (by weight) |
| | | Proxel ® GXL (30% by weight) in water |
| | | and 9.00% (by weight) n-propyl alcohol |
| III | 10.00 parts | water-dissipatable sulfopolyester polymer |
| | | at 30% (by weight) in water |
| | 100.00 parts | |

Components I-III were combined to produce an ink formulation containing about 60 ppm of Dye IV (Table 1). Ink drawdowns were made on Springhill 20 lb paper using RK #1 rod and RK Coater at 3.5 speed setting and produced a high degree of fluorescence in the 780 nm range.

### EXAMPLE 27

Repeated Example 26 Where Component I is Now 10.0 Parts Dye VII (Table 1) Dispersion From Example 22(D) which is Equivalent to 0.06% (by Weight) Dye, 80 Parts Component II and 10.0 Parts Component III.

### EXAMPLE 28

Preparation of Inkjet Ink from Dye VII (Table 1) at About 0.06% (by Weight) or 600 ppm Concentration for Continuous Inkjet Printing and with 3.0% (Dry Weight) Water-Dissipatable Sulfopolyester Polymer.

| Components | Parts | |
|---|---|---|
| I | 10.00 parts | 0.06 wt % Dye VII (Table 1) dispersed in |
| | | propylene glycol (98.04 wt %), 1.0 wt % |
| | | Surfynol 465 Surfactant |
| II | 80.00 parts | inkjet vehicle containing 37.70% (by weight) |
| | | propylene glycol, 53.20% (by weight) |
| | | deionized water, 0.05% (by weight) |
| | | corrosion inhibitor, 0.05% (by weight) |
| | | Proxel ® GXL (30% by weight) in water |
| | | and 9.00% (by weight) n-propyl alcohol |
| III | 10.00 parts | water-dissipatable sulfopolyester polymer |
| | | at 30% (by weight) in water |
| | 100.00 parts | |

### EXAMPLE 29

Repeated Example 26 where Component I is now 10.0 parts Dye X (Table 1) dispersion from Example 25(D) which is equivalent to 0.06% (by weight) dye, 80.0 parts Component II and 10.0 parts Component III.

### EXAMPLE 30

Premix of Sulfopolyester/Amide with Near-Infrared Fluorescent Dye on Leistritz Twin-Screw Extruder:

663.37 g of Eastman AQ™-48 water dispersible polyester and 17.01 g of Dye III (Table 1) were weighed separately and then physically blended. The blend was dried for 3 days at =50° C. in a vacuum oven. The dried sample was melt extruded at 250° C., 400 rpm, on a Leistritz twin-screw extruder. The product was extruded as a rod onto a chilled belt and pelletized. The final product analyzed 1.3 wt % of Dye III by UV/Visible Spectroscopy.

### EXAMPLE 31

Preparation of Aqueous Dispersion From Example 30:

95.38 g of demineralized water and 4.62 g of the extruded premix from Example 30 were placed in a 300-ml 3-neck round-bottom flask with stirrer and Teflon paddle. The sample was heated with stirring to 50° C. and held for 15 minutes. The temperature was increased to 70° C., and the sample held for an additional 30 minutes. This sample was cooled and filtered through 2 layers of cheesecloth. A green dispersion with 4.62 wt % solids and 600 ppm Dye III (Table 1) was obtained. The dispersion exhibited fluorescence in the near-infrared.

### COMPARATIVE EXAMPLES

### Comparative Example 1

Preparation of Inkjet Ink From Dye I (Table 1) for Continuous Inkjet Printing with NO Water-Dissipatable Sulfopolyester Polymer.

| Components | Parts | |
|---|---|---|
| I | 5.00 parts | Example 2 |
| II | 28.90 parts | propylene glycol |
| III | 57.00 parts | deionized water |
| IV | 0.05 parts | corrosion inhibitor (50% by weight solution |
| | | of 1H-benzotriazole (PMC Specialties) in |
| | | propylene glycol |
| V | 0.05 parts | Proxel ® GXL (30% by weight in water) |
| VI | 9.00 parts | n-propyl alcohol |
| | 100.00 parts | |

Components I-VI were combined to produce an inkjet ink containing about 60 ppm of the monomeric dye and no water-dissipatable sulfopolyester polymer. When an ink drawdown was made on Springhill 20 lb. paper using RK#1 rod and RK Coater at 3.5 speed setting, the ink provided no measurable fluorescent voltage signal using the AccuSort L1.0 Scanner at 620 nm. The fluorescence visibility through a handheld CCD camera could hardly be detected.

TABLE 1
NAMES STRUCTURES AND SUPPLIERS OF MONOMERIC DYES

| Dye # | Chemical Name (and aliases) | CAS # | Structure | Supplier/Source |
|---|---|---|---|---|
| 1 | Aluminum phthalocyanine chloride | 38496-97-8 | 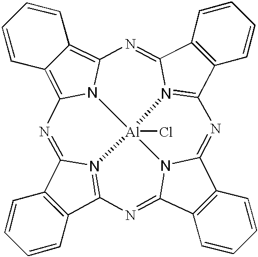 | Aldrich Chemical Company |
| II | Aluminum phthalocyanine(3,5-dicarbo- methoxyphenoxide) | 167093-18-7 | 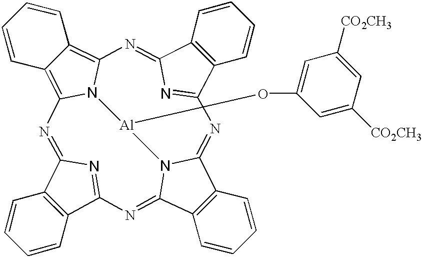 | U.S. Pat. No. 5,397,819 |
| III | 1(4),8(11),15(18),22(2S)-tetraks((4-(2- ethylhexoxy) carbonyl)phenoxy)phthalocyanine | NA | 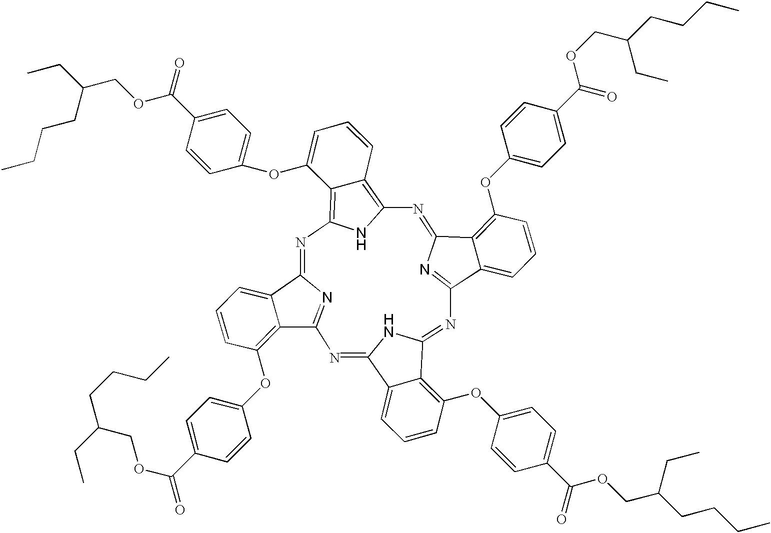 | U.S. Pat. No. 5,525,616 |
| IV | 1,1,3,3,3,3-Hexamethyl-4,4,5,5- dibenzo-2,2-indotricarbocyanine perchlorate (HDITC) | 23178-67-8 | 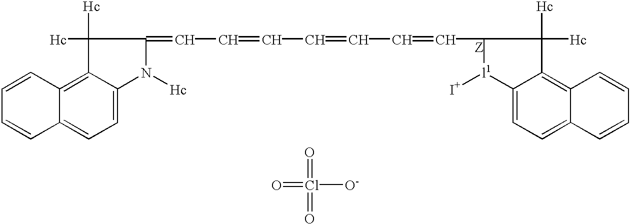 | Eastman Kodak Company Lambda Physik Inc. (Lambdachrome ®Laser Dyes) |
| V | 5,5-Dichloro-11-(diphenylamino)- 3,3-diethyl-10,12-ethylenethiatri- carbocyanine perchlorate (IR-140) | 53655-17-7 | 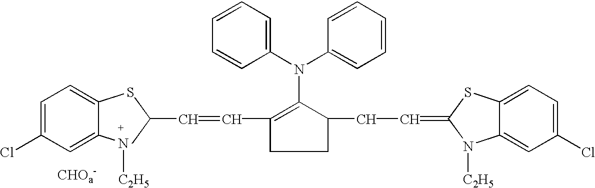 | Eastman Kodak Company Lambda Physik Inc. (Lambdachrome ®Laser Dyes) |
| VI | Naptho (2,3-D) thiazolium perchlorate (IR-132) | 62669-62-9 | 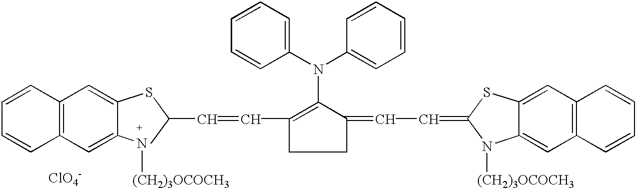 | Eastman Kodak Company Lambda Physik Inc. (Lambdachrome ®Laser Dyes) |
| VII | 4,5-Benzoindotricarbocyanine (IR-125) | 3599-32-41 | 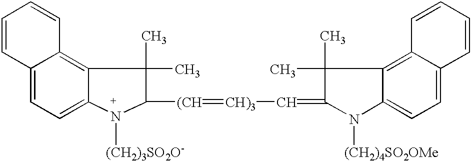 | Eastman Kodak Company Lambda Physik Inc. (Lambdachrome ®Laser Dyes) |
| VIII | 1,1-Diethyl-4,4-dicarbocyanine iodide (DDCI-4) | 18300-31-7 | 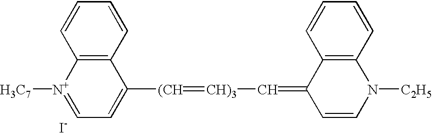 | Aldrich Chemical Company Lambda Physik Inc. (Lambdachrome ®Laser Dyes) |
| IX | 3,3-Diethylthiatricarbocyanine iodide (DTTCI) | 3071-70-3 | 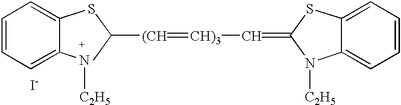 | Eastman Kodak Company Lambda Physik Inc. (Lambdachrome ®Laser Dyes) |
| X | 1,1,3,3,3,3-Hexamethyl- indotricarbocyanine iodide (HITCI) | 19764-96-6 | 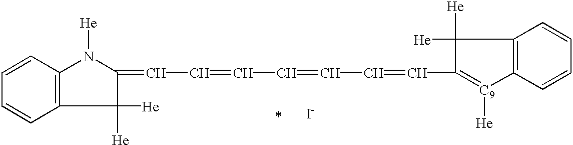 | Aldrich Chemical Company |

Supplier Addresses:
Aldrich Chemical Company 1001 West Saint Paul Ave. Milwaukee, WI 53233
Eastman Kodak Company Rochester, NY 14650
Lambda Physik Inc. (Lambdachrome ® Laser Dyes) 3201 West Commercial Blvd. Fort Lauderdale, FL 33309

What is claimed is:

1. An aqueous ink composition suitable for use in inkjet printing comprising:
A. between about 0.001 and 1.0 weight percent, based on total weight of the composition, of at least one monomeric dye which fluoresces at wavelengths longer than about 600 nm,
B. between about 0.5 and 10.0 weight percent, based on the total weight of the composition, of at least one water dissipatable sulfopolyesterlamide comprising:
monomer residues of at least one dicarboxylic acid;
about 4 to 25 mole percent, based on the total of all acid, hydroxy and amino equivalents, of monomer residues of at least one difunctional sulfomonomer containing at least one sulfonate group bonded to an aromatic ring where the functional groups are hydroxy, carboxyl, carboxylate ester or amino, and
monomer residues of at least one diol or a mixture of diol and a diamine;
C. between about 2 and 75 weight percent of at least one aliphatic polyol containing 2 or 3 carbon atoms;
D. between about 0 and 15 weight percent of at least one lower aliphatic alcohol of no more than 3 carbon atoms; and
E. between 0 and about 2 weight percent, based on the total weight of the composition, of one or more additives selected from the group consisting of a surface active agent, a defoaming agent, a corrosion inhibitor, and a biocide;
F. the remainder of the said ink consisting essentially of water.

2. A composition as in claim 1 wherein the water dissipatable sulfopolyester/amide further comprises
monomer residues of at least one difunctional monomer reactant selected from hydroxycarboxylic acids, amino carboxylic acids and amino alkanols.

3. A composition as in claim 1 wherein the fluorescent dye is selected from the group consisting of a phthalocyanine, a cyanine, a naphthalocyanine, and a squaraine.

4. A composition as in claim 1 wherein the aliphatic polyol is selected from the group consisting of ethylene glycol, propylene glycol, diethylene glycol, triethylene glycol, glycerol and a mixture thereof.

5. A composition as in claim 1 wherein the aliphatic alcohol is selected from the group consisting of methanol, ethanol, n-propanol, isopropanol, ethylene glycol mono C1-C2 alkyl ethers and a mixture thereof.

6. A composition as in claim 1 wherein the monomeric dye is a chemical compound which provides the composition with minimal light absorption of radiation in the visible range 400-700 nanometers (nm) and strong light absorption in the near infrared region about 700-900 nm with accompanying fluorescence to produce fluorescent radiation of wavelengths longer than the wavelength of excitation.

7. A composition as in claim 1 which comprises
between 45 and 75 weight percent of the at least one aliphatic polyol containing 2 or 3 carbon atoms;
between about 2 and about 15 weight percent of the at least one lower aliphatic alcohol of no more than 3 carbon atoms;
between about 0.01 and about 0.50 weight percent of the at least one corrosion inhibitor; and
between about 0.01 and about 0.30 weight percent of the at least one biocide.

8. A composition as in claim 1 which comprises
between about 20 and about 60 weight percent of the at least one aliphatic polyol containing 2 or 3 carbon atoms;
between about 0 and about 1.50 weight percent of at the least one surface active agent;
between about 0.01 and about 0.50 weight percent of at the at least one corrosion inhibitor;
and
between about 0.01 and about 0.30 weight percent of the at least one biocide.

9. A composition as in claim 1 which comprises
between about 2 and about 8 weight percent of the at least one aliphatic polyol containing 2 or 3 carbon atoms;
between about 0.35 and about 0.65 weight percent of the at least one surface active agent;
between about 0.75 and about 1.25 weight percent of the at least one defoaming agent;
between about 0.01 and about 0.50 weight percent of the at least one corrosion inhibitor; and
between about 0.01 and about 0.30 weight percent of the at least one biocide.

10. A composition as in claim 1 which comprises
between about 20 and about 40 weight percent of the at least one aliphatic polyol containing 2 or 3 carbon atoms;
between about 5 and about 15 weight percent of the at least one aliphatic alcohol containing no more than 3 carbon atoms;
between about 0.01 and about 0.50 weight percent of the at least one corrosion inhibitor; and
between about 0.01 and about 0.30 weight percent of the at least one biocide.

11. A fluorescent dye composition suitable for use as a component in an inkjet ink, said composition comprising
from about 1 to 1000 parts by weight of at least one monomeric dye which fluoresces at wavelengths longer than about 600 nm, and
from about 500 to about 10,000 parts by weight of at least one water dissipatable sulfopolyester/amide comprising:
monomer residues of at least one dicarboxylic acid;
about 4 to 25 mole percent, based on the total of all acid, hydroxy and amino equivalents, of monomer residues of at least one difunctional sulfomonomer containing at least one sulfonate group bonded to an aromatic ring where the functional groups are hydroxy, carboxyl, carboxylate ester or amino, and
monomer residues of at least one diol or a mixture of diol and a diamine.
wherein the monomeric dye is dispersed throughout the water dissipatable sulfopolyester/amide.

12. A fluorescent dye composition suitable for use as a component in an inkjet ink, said composition consisting essentially of a melt blended extrudate of from about 1 to 1000 parts by weight of at least one monomeric dye which fluoresces at wavelengths longer than about 600 nm, and
from about 500 to about 10,000 parts by weight of at least one water dissipatable sulfopolyester/amide comprising:
monomer residues of at least one dicarboxylic acid;
about 4 to 25 mole percent, based on the total of all acid, hydroxy and amino equivalents, of monomer residues of at least one difunctional sulfomonomer containing at least one sulfonate group bonded to an aromatic ring where the functional groups are hydroxy, carboxyl, carboxylate ester or amino, and
monomer residues of at least one diol or a mixture of diol and a diamine.
wherein the monomeric dye is dispersed throughout the water dissipatable sulfopolyester/amide.

13. A composition as in claim 11 wherein fluorescent dye is a water insoluble dye selected from the group consisting of a phthalocyanine, a cyanine, a naphthalocyanine, and a squaraine.
